(19) United States
(12) Patent Application Publication
(10) Pub. No.: US 2007/0020067 A1
(43) Pub. Date: Jan. 25, 2007

(54) Storage cassette for large panel glass substrates

(75) Inventors: Chi-Feng Lin, Kaohsiung City (TW); Meng-Hsueh Hsieh, Pusin Township (TW)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: AU Optronics Corporation

(21) Appl. No.: 11/187,460

(22) Filed: Jul. 22, 2005

(51) Int. Cl. B65G 1/20

(52) U.S. Cl. 414/331.09; 414/811

(57) ABSTRACT

In a cassette having racks for storing glass substrates, rollers are used to support a glass substrate in a rack and to move the glass substrate into and out of the cassette. Two rows of interlocking gears are used to rotate the rollers in the same direction. A transfer platform having a plurality of rollers and two rows of interlocking gears is used as a conveyor to deliver or retrieve a glass substrate to or from the cassette after the gears on the transfer platform are also engaged with the gears on a cassette stage. Alternatively, the rollers on the cassette racks and on the transfer platform are driven by inter-linking belts or chains. In a different embodiment, rollers are driven by magnetic coupling devices mechanically linking the transfer platform and the rack through magnetic coupling.

### FIELD OF THE INVENTION

The present invention relates generally to a cassette for storing glass substrates and, more particularly, to a cassette for storing glass substrates during the process of making large panel displays such as TFT liquid crystal displays, including the process steps of making arrays, cells and color filters.

### BACKGROUND OF THE INVENTION

In the process of making large panel displays, such as liquid crystal displays, glass plates are used as substrates, these glass substrates must be stored in a multi-level container or cassette before and after the glass substrates are processed. When dealing with small-sized glass substrates, a cassette having a multi-level frame is usually used. A robot arm is programmed to place one glass substrate at a time into a rack in the cassette. Each rack has a plurality of support pins to support the glass substrate. The same robot arm is also used to retrieve the glass substrates one at a time from the cassette. A typical pin-rack cassette is shown in FIGS. 1A and 1B. FIG. 1B shows a front view of the cassette. FIG. 1A shows a side view of the cassette in relation to the robot arm. As shown in FIG. 1A, the robot arm can be moved up and down to reach the level of a particular rack so that the robot arm can place or retrieve a glass substrate into or from the particular rack.

When dealing with larger-sized glass substrates, a roller conveyor is used to put or retrieve a glass substrate into or from a wire cassette. A typical wire cassette is shown in FIGS. 2A and 2B. FIG. 2A shows a side view of the cassette, which can be moved up and down to adjust the level of a rack to the level of the roller conveyor. FIG. 2B shows a cross section of the cassette as viewed through the front of the wire cassette. The cassette has a number of wire racks, each of which comprises a plurality of parallel wires extending from left to right of the cassette for holding a glass substrate. The roller conveyor comprises a plurality of rollers, each of which is mounted on an upright support. The upright supports can be inserted through the wire cassette between the wires. In order to remove a glass substrate from the cassette, the cassette must be lowered so as to allow the lowest substrate in the stack to be rolled out by the rollers. When the glass substrates are put in by the roller conveyor, the vertical position of the cassette must be adjusted so that the topmost available empty rack can receive a glass substrate from the roller conveyor. Unlike the pin-rack cassette where a glass substrate at any rack can be taken out by the robot arm, the wire cassette requires that the substrates be stored or taken out in a sequential manner. It is impossible to use the roller conveyor to remove a glass substrate without first removing those in the bottom of the stack.

Thus, it is advantageous and desirable to provide a cassette having a plurality of racks for storing larger-sized glass substrates, wherein any rack is randomly accessible to a conveyor.

### SUMMARY OF THE INVENTION

The present invention uses a plurality of rollers in each cassette rack to move a glass substrate into and out of the cassette. Two rows of interlocking gears are used to rotate the rollers in the same direction and at the same speed. The rollers are also used as the mechanical supports for the glass substrate in each rack. A transfer platform having a plurality of rollers and two rows of interlocking gears is used as a conveyor to deliver or retrieve a glass substrate to or from the cassette after the gears on the transfer platform are also engaged with the gears on a cassette stage.

Alternatively, the rollers on the cassette racks and on the transfer platform are driven by inter-linking belts or chains.

In a different embodiment, the rollers are driven by magnetic coupling devices. In this embodiment, each roller is fixedly attached to a magnetic rotor at one end of the roller shaft. Each magnetic rotor is placed in the vicinity of a magnetically inducing rotor, which can set the magnetic rotor into rotation when the inducing rotor rotates along an orthogonal axis. In order to cause the rollers to rotate at the same speed in the same direction, a plurality of inducing rotors are fixedly mounted on a motion control shaft for rotation along with the shaft. The motion control shaft is placed perpendicular to the rollers such that each inducing rotor is positioned next to a magnetic roller. A motor is used to rotate the motion control shaft in a clockwise or a counter-clockwise direction so as to move a substrate on the rollers in a desired direction.

The magnetically driven rollers can be used in both the cassette and the transfer platform. The coupling between a cassette rack and the transfer platform can be magnetic or mechanical.

The present invention will become apparent upon reading the description taken in conjunction with FIGS. 3A to 11.

### BRIEF DESCRIPTION OF THE DRAWINGS

FIG. 1A shows a prior art cassette in relation to a robot arm.

FIG. 1B shows a front view of the cassette of FIG. 1A.

FIG. 2A shows a wire cassette in relation to a roller conveyor.

FIG. 2B shows a cross sectional view of the wire cassette.

FIG. 3A is a schematic representation showing a side view of a roller cassette in relation to a transfer platform, according to the present invention.

FIG. 3B is a schematic representation showing a top view of the roller cassette and the transfer platform, according to the present invention.

FIG. 4A shows a side view of the roller cassette alone.

FIG. 4B shows a front view of the roller cassette.

FIG. 4C shows a top view of a roller rack in the roller cassette.

FIG. 5 shows a roller.

FIG. 6 shows a top view of the transfer platform.

FIG. 7A shows the top view of the transfer platform in relation to a roller rack.

FIG. 7B shows the transfer platform being mechanically engaged with the roller rack.

FIG. 7C shows a glass substrate being moved from the transfer platform toward the roller rack.

FIG. 7D shows the glass substrate being placed on the roller rack.

FIG. 8 shows a different roller rack with interlocking gears.

FIG. 9 shows another different roller rack having inter-linking belts or chains.

FIG. 10 is a schematic representation showing a magnetically coupled transfer platform in relation to a magnetically coupled roller rack.

FIG. 11 shows a section of a roller shaft having a magnetic rotor in relation to an inducing rotor.

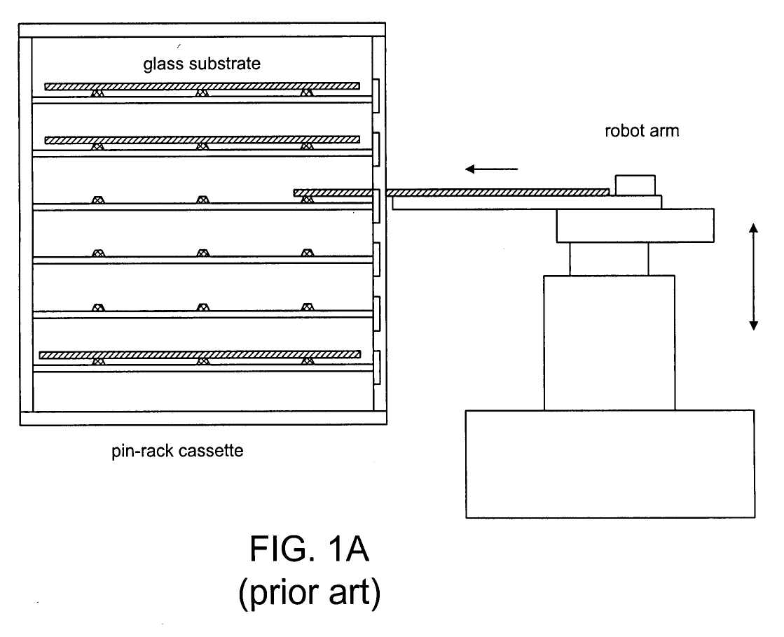

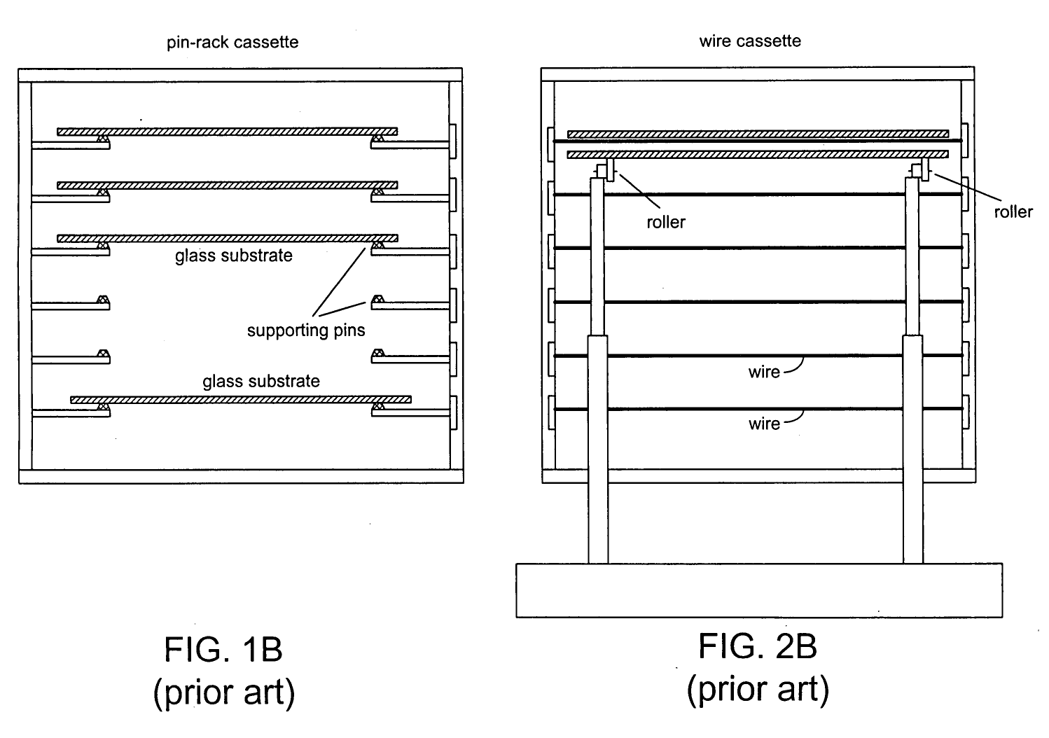

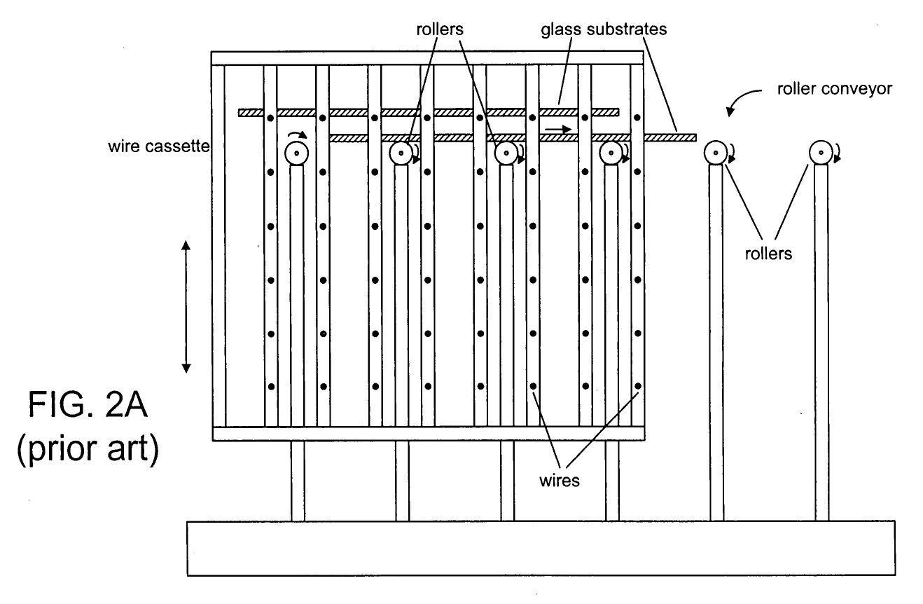

### DETAILED DESCRIPTION OF THE INVENTION

The present invention uses rollers to move a glass substrate either in a storage cassette or in a transfer conveyor. The rollers are mechanically engaged with each other through a plurality of interlocking gears. In a different embodiment, the rollers are mechanically engaged with each other through a plurality of inter-linking chains or belts. In a further embodiment, the rollers are linked with each other with magnetic coupling devices.

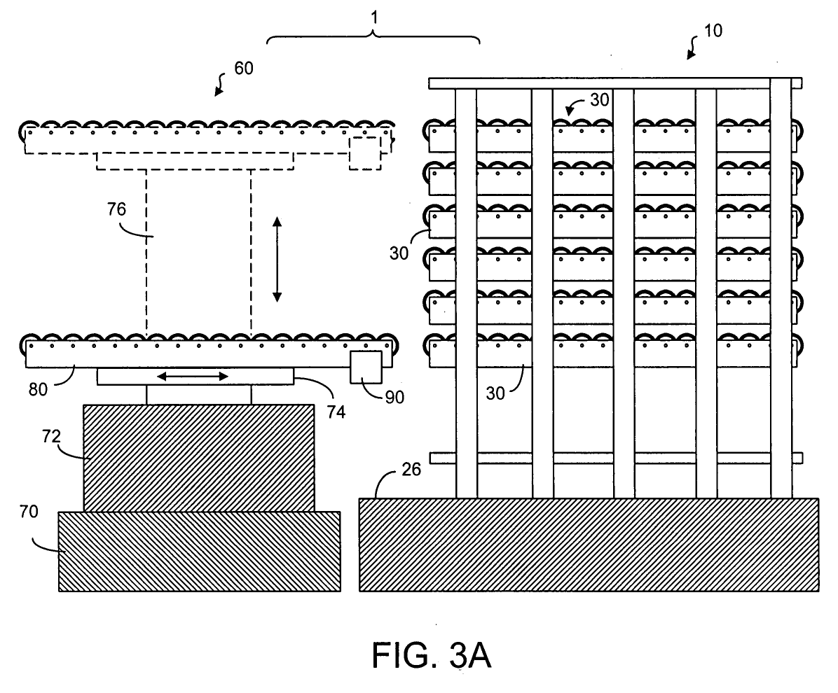

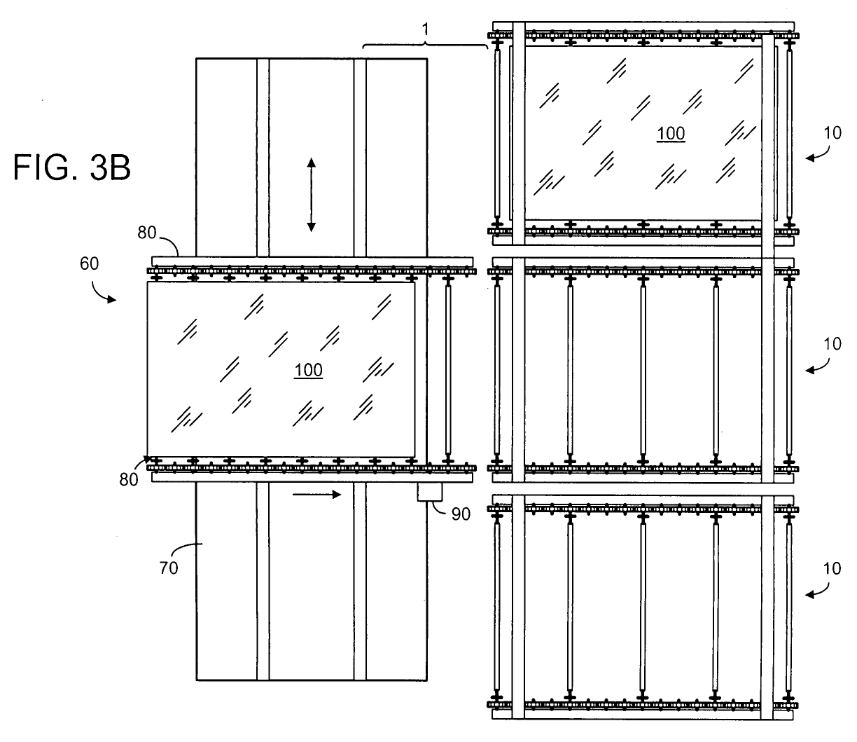

Referring now to FIG. 3A and 3B, the present invention uses a transfer conveyer 60 to move glass substrates one at time to or from a roller cassette 10. In the transfer system 1 as shown in FIG. 3B, one or more roller cassettes 10 are placed in a row next to the transfer conveyor 10, which can be moved laterally on a foundation 70. Each of the roller cassettes 10 has a plurality of roller racks 30, each for storing a glass substrate 100. The transfer conveyor 60 has a transfer platform 80 movably mounted on another lateral movement device 74 so that the transfer platform 80 can be mechanically engaged to one of the roller racks 30. The lateral movement device 74 is movably mounted on a vertical movement device 76 extended out from a base 72.

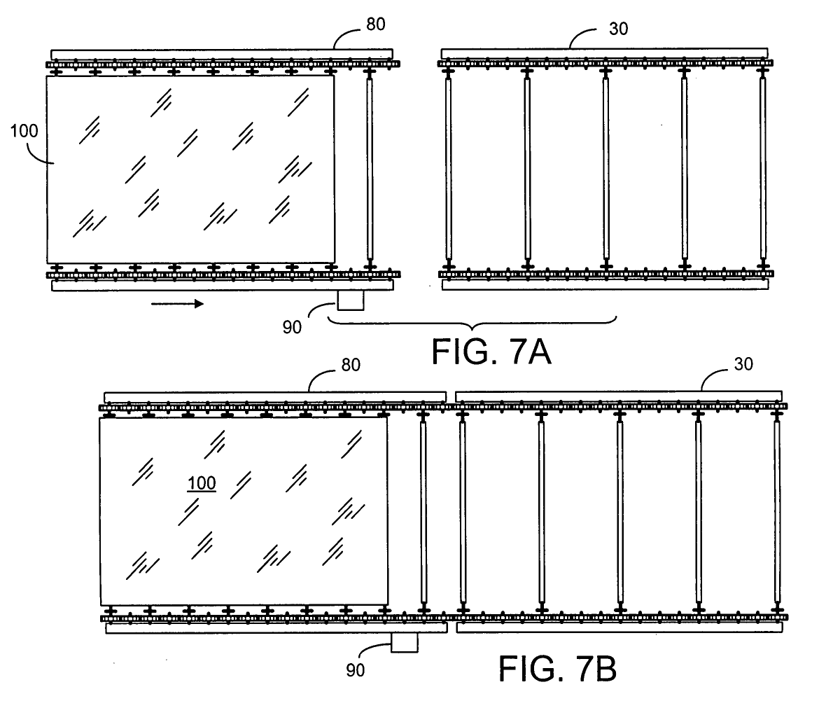

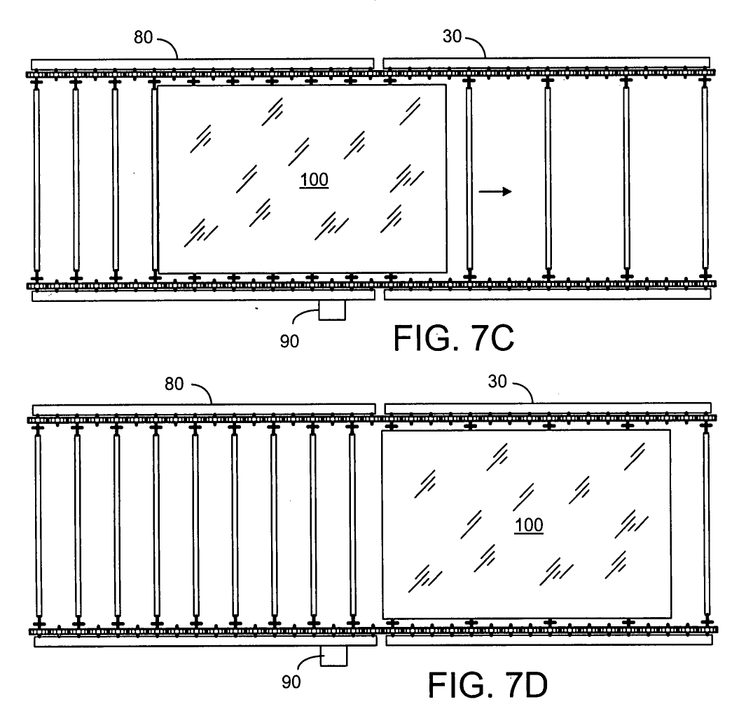

When a glass substrate 100 is to be transferred between a particular roller rack 30 and the transfer conveyor 60, the vertical movement device 76 is programmed to adjust the height of the transfer platform 80 to the height of that particular roller rack. Subsequently, the lateral movement device 74 causes the transfer platform 80 to move toward the roller cassette 10 so as to mechanically engage the transfer platform 80 to that particular roller rack. As can be seen from FIG. 3A, the transfer platform 80 can be raised or lowered to match the height of any roller cassette 30 in a roller cassette 10, a glass substrate 100 in any roller cassette 30 can be randomly accessed. Furthermore, the roller cassette 10 operates in a passive manner in that it does not require a dedicated power source to move the glass substrates in and out. As will be illustrated in FIGS. 7B-7D, the glass substrates are moved by a motor 90 in the transfer conveyor 60.

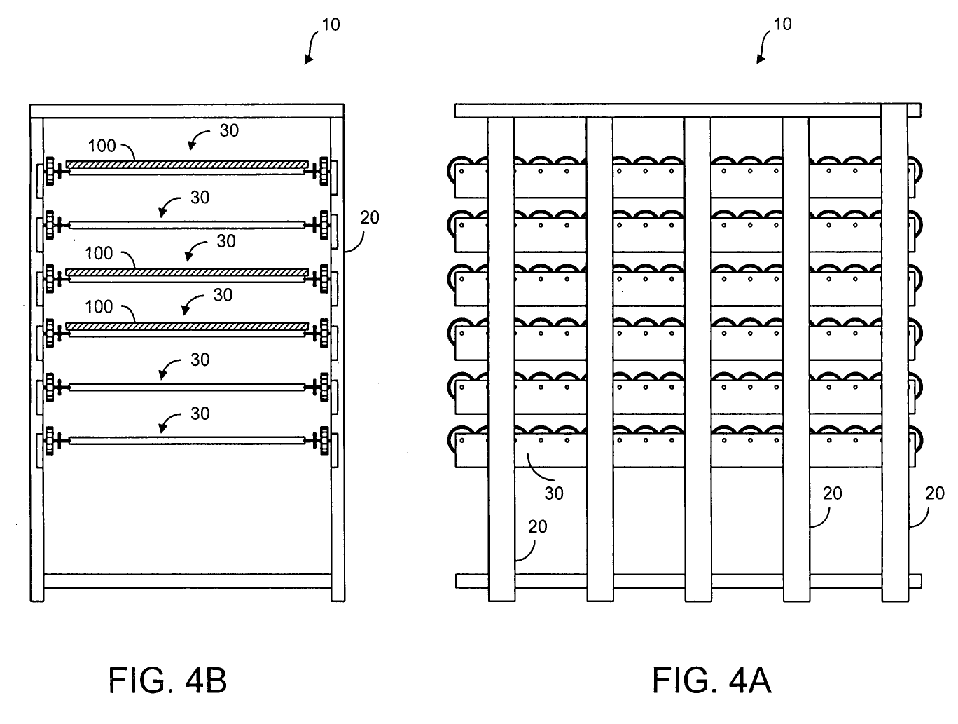

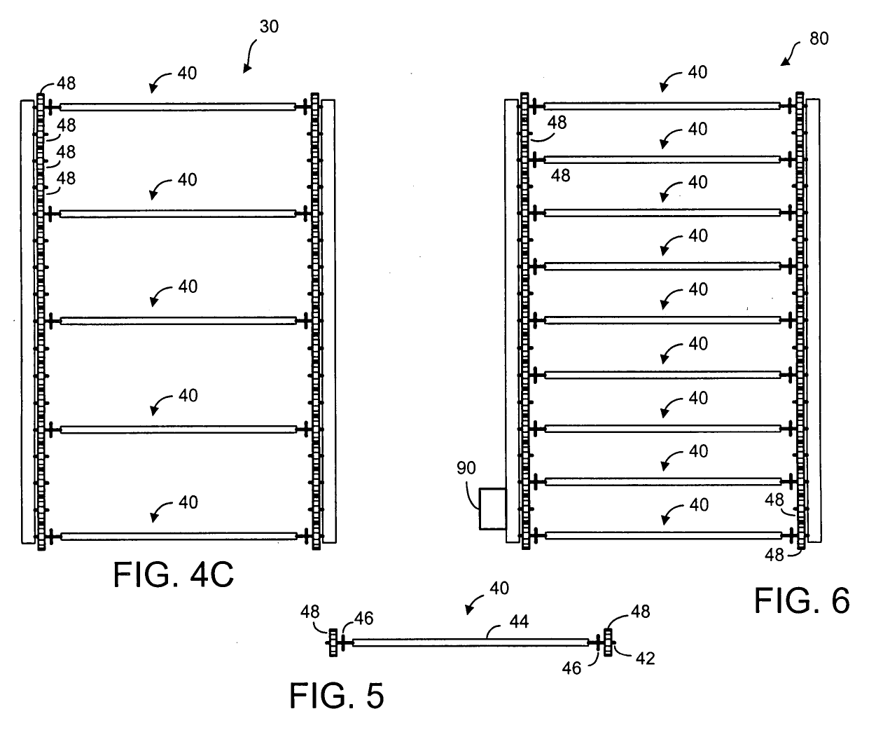

Referring now to FIGS. 4A to 4B, the roller cassette 10, according to the present invention, comprises a frame 20 on which a plurality of substantially parallel roller racks 30 are fixed mounted. Each rack 30 can be used to support a glass substrate 100. FIG. 4A is a side view of the roller cassette 10 and FIG. 4B is a front view. FIG. 4C is a top view of a roller cassette 30. As shown in FIG. 4C, a roller rack 30 comprises a plurality of rollers 40, mechanically engaged with each other through two rows of interlocking gears 48 such that the rollers 40 on a roller rack 30 are caused to rotate at the same time and in the same direction. Each roller 40 has a cylindrical member 44 fixedly mounted on a shaft 42, as shown in FIG. 5. The roller 40 further comprises a pair of gears 48 fixedly mounted on the shaft 42 and a pair of roller guides 46 to guide a glass substrate when the glass substrate is moved by the cylindrical member 44.

The transfer platform 80 on the transfer conveyor 60 is similarly constructed. FIG. 6 is a top view of the transfer platform 80. As shown, the transfer platform 80 comprises a plurality of rollers 40 mechanically engaged with each other through a plurality of interlocking gears 48. In addition, a motor 90 or a similar movement device is used to set the rollers 40 on the transfer platform 80 in rotational motion through the interlocking gears 48.

FIGS. 7A-7C illustrate how a glass substrate 100 is transferred from the transfer platform 80 to a roller rack 30. Initially, the transfer platform 80 is physically separated from the roller rack 30, as shown in FIG. 7A. The transfer platform 80 is then moved toward the roller rack 30 by the lateral movement device 74 (see FIG. 3A) until the gears on the transfer platform 80 become interlocked with the gears on the roller rack 30, as shown in FIG. 7B. Subsequently, the motor 90 sets the rollers on the transfer platform 80 in motion so as to move the glass substrate 100 toward the roller rack 30, as shown in FIG. 7C. Because the gears on the transfer platform 80 are also interlocked with the gears on the roller rack 30, the rollers on the roller rack 30 are also caused to rotate at the same speed and in the same direction. As such, the rollers on the roller rack 30 are able to move the glass substrate into the roller cassette 10 (FIGS. 3A and 3B). When a glass substrate is to be moved out of the roller cassette 10, the process is similar but reversed.

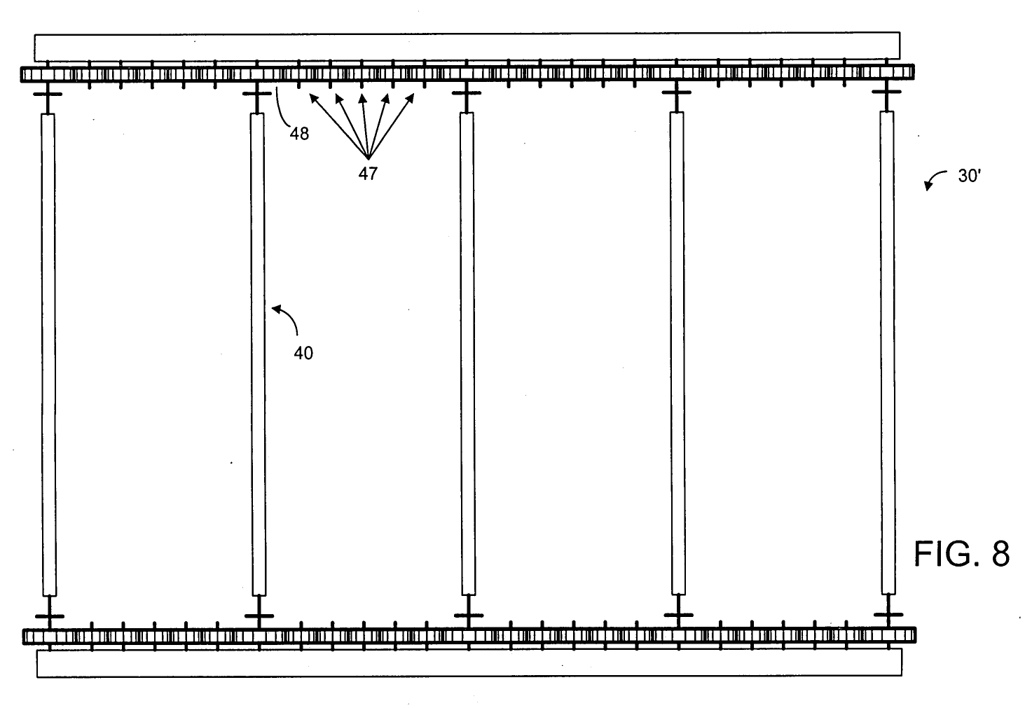

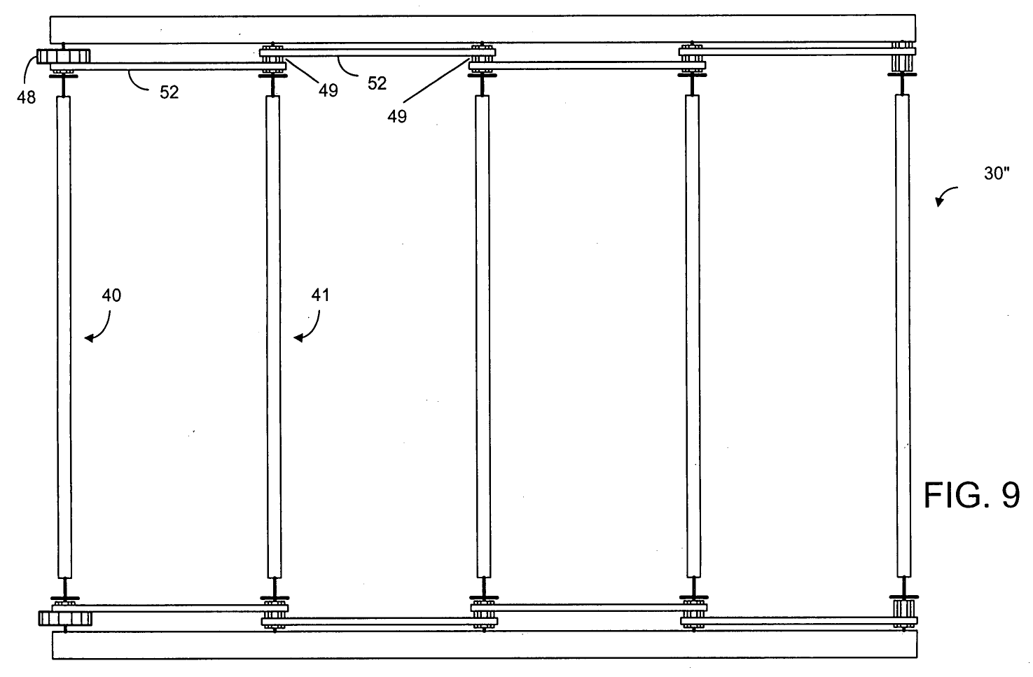

As shown in FIGS. 3B, 4C, 6 and 7A-7D, the number of rollers on a roller rack 30 is smaller than the number of rollers on the transfer platform 80. It is so designed to reduce the weight of the roller cassette 10. The weight can be further reduced by using gears of different sizes. For example, the gears disposed between two rollers 40 on a roller rack 30′ can be of a smaller size. As shown in FIG. 8, five smaller gears 47 are used between two adjacent rollers 40, instead of three larger gears 48 (see FIG. 4C). Furthermore, the mechanical linkage between rollers can be achieved by using belts and chains, instead of gears. For example, in the roller rack 30″ as shown in FIG. 9, only one pair of gears 48 on one roller 40 are used to provide mechanical coupling between the roller rack and the transfer platform 80 (see FIG. 7B-7D). All other rollers 41 have grooved or knurled cylinders 49 to provide frictional surfaces to the belts or chains 52. As with the roller rack 30 of FIG. 4C and the roller rack 30′ of FIG. 8, the rollers 41 are caused to rotate at the same speed and in the same direction as the roller 40. Moreover, some of the gears in the transfer platform 80 can also be replaced by smaller gears or by belts and chains, similar to the mechanical coupling as shown in FIGS. 8 and 9.

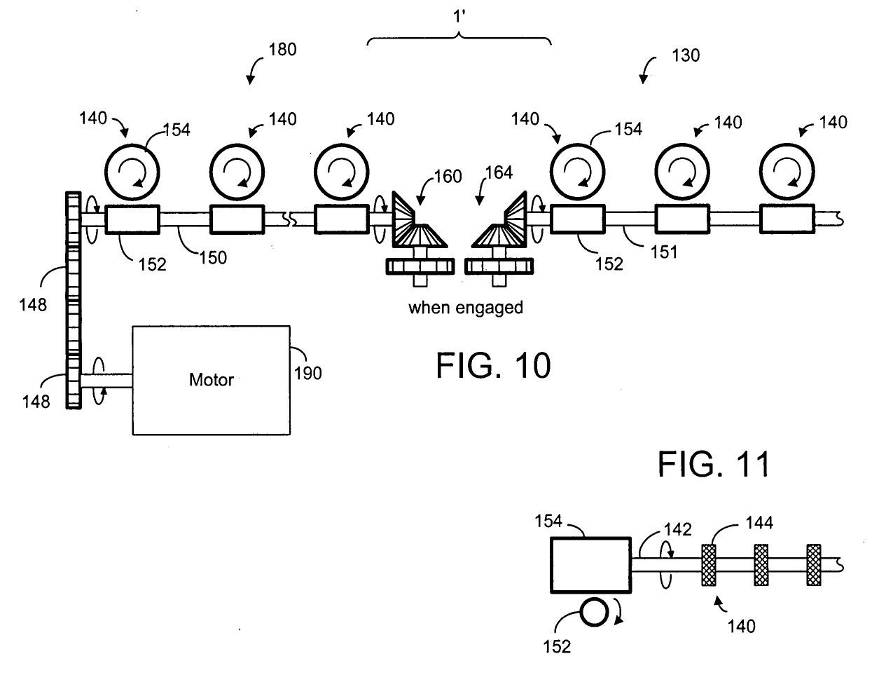

In a different embodiment, the transfer platform and the roller rack use magnetic coupling devices to move the rollers. As such, rollers are not mechanically linked to each other. In the embodiment as shown in FIGS. 10 and 11, a transfer platform 180 uses a plurality of rollers 140 as transferring means. As shown in FIG. 11, a roller 140 comprises a shaft 142 for mounting a magnetic rotor 154 on one shaft end. Instead of having a single cylindrical member 44 as shown in FIG. 5, the roller 140 has a plurality of separate rollers 144 for moving a glass substrate. The rollers 144 are rotatably mounted on a frame (not shown). As shown in FIG. 10, the transfer platform 180 comprises a motion control shaft 150 for fixedly mounting a plurality of magnetically inducing rotors 152 which are caused to rotate along with the motion control shaft 150. Each of the inducing rotors is positioned in close proximity of a magnetic rotor 154. The motion control shaft 150 is mechanically connected to a motor 190 through one or more gears 148. When the motion control shaft 150 and the inducing motors 152 are caused to rotate by the motor 190, the changing magnetic field around each inducing motor 152 sets the nearby magnetic rotor 154 in motion in a synchronous fashion.

Similarly, the roller rack 130 comprises a plurality of rollers 140 and a motion control shaft 151 for fixedly mounting a plurality of magnetically inducing rotors 152 next to the magnetic rotors 154. The motion coupling between the transfer platform 180 and the roller rack 130 can be achieved by many different ways. For example, a gear system 160, 164 can be used to mechanically link the motion control shaft 150 to the motion control shaft 151.

In sum, in the substrate transfer system of the present invention, one transfer conveyor having a transfer platform can be used to transfer glass substrates from one or more roller cassettes, one substrate at a time. Each cassette has a plurality of roller racks for storing a plurality of glass substrates. The transfer platform and the roller rack use a plurality of rollers to move a glass substrate in a lateral direction. The rollers can be mechanically linked to each other by gears, belts, chains or similar mechanical components so that they can rotate in synchronization. Alternatively, the rollers can be magnetically linked to each other using magnetic rotors and the like. The rollers in the roller cassette are caused to rotate synchronously with the rollers in the transfer conveyor only when the transfer platform is engaged with a roller rack in a roller cassette.

It should be noted that the transfer platform and the roller cassettes can also be used for moving and storing other flat panels made of a different material such as metal, plastic or the like. Furthermore, it is possible to dispose the gears and the magnetic coupling devices on the racks and the gears on the transfer platform only on one side of the rack or platform. It is also possible to dispose the gears and the magnetic coupling device on the racks and the transfer platform between and away from the two sides of the rack or platform. Moreover, the racks on the roller cassettes and the transfer platform can be structurally the same or different.

Thus, although the invention has been described with respect to one or more embodiments thereof, it will be understood by those skilled in the art that the foregoing and various other changes, omissions and deviations in the form and detail thereof may be made without departing from the scope of this invention.

What is claimed is:

1. A cassette for storing a plurality of substantially flat panels, comprising:
a frame having a first side and an opposing second side; and
a plurality of racks separately disposed on the frame at different levels, each rack adapted to store a flat panel, wherein each of the racks comprises:
a plurality of rollers for supporting the flat panel, each roller capable of rotating along a rotational axis in a first direction or in an opposing second direction, wherein the rollers are motionally engaged with each other such that the rollers can be caused to rotate simultaneously; and
a mechanical coupling mechanism disposed on the first side of the rack, the coupling mechanism motionally engaged with the rollers, wherein the coupling mechanism is adapted to engage mechanically with a movement means so that the rollers can be caused by the movement means through the coupling mechanism to rotate simultaneously in the first direction for moving the flat panel from the first side to the second side, or to rotate simultaneously in the second direction for moving the flat panel from the second side to the first side.

2. The cassette of claim 1, wherein each of the rollers is mounted on a shaft for rotation, the shaft comprising at least one shaft gear fixedly disposed on the shaft, and the plurality of rollers on each rack include one or more adjacent roller pairs, and wherein the rack further comprises mechanical coupling means for mechanically engaging the shaft gears on the shafts of the rollers in each adjacent roller pair for motionally engaging said adjacent roller pair.

3. The cassette of claim 1, wherein the shaft has a first shaft end and a second shaft end, and said at least one shaft gear is fixedly disposed on the first shaft end.

4. The cassette of claim 3, where the shaft further comprises a further shaft gear fixedly disposed on the second end, and wherein the rack further comprises further mechanical coupling means for mechanically engaging the further shaft gears on the second end of the shafts of the rollers in said each adjacent roller pair for motionally engaging said adjacent roller pair.

5. The cassette of claim 4, wherein each of the mechanical coupling means and the further mechanical coupling means comprises an odd-number of coupling gears.

6. The cassette of claim 5, wherein the shaft gear has a first gear size, and the coupling gears have a second gear size substantially equal to the first gear size.

7. The cassette of claim 5, wherein the shaft gear has a first gear size, and at least one of coupling gears has a second gear size smaller than the first gear size.

8. The cassette of claim 1, wherein each of the rollers is mounted on a shaft for rotation, and the plurality of rollers on each rack include one or more adjacent roller pairs, and wherein the rack further comprises one or more belts, each belt mechanically engaging with the shafts of the rollers in each adjacent roller pair for motionally engaging said adjacent roller pair.

9. The cassette of claim 1, wherein each of the rollers is mounted on a shaft for rotation, and the plurality of rollers on each rack include one or more adjacent roller pairs, and wherein the rack further comprises one or more chains, each chain mechanically engaging with the shafts of the rollers in each adjacent roller pair for motionally engaging said adjacent roller pair.

10. The cassette of claim 1, wherein each of the rollers is mounted on a shaft for rotation, the shaft comprising at least one magnetic rotor fixedly disposed on the shaft, and wherein the rack further comprises:
a common shaft mechanically engaged with the mechanical coupling mechanism; and
a plurality of magnetically inducing rotors fixedly mounted on the common shaft, each of the inducing rotor is positioned in relation with a magnetic rotor for providing magnetic coupling between said inducing rotor and said magnetic rotor, such that when the common shaft is caused to turn by the movement means through the mechanical coupling mechanism, the inducing rotors are also caused to turn along with the common shaft, the magnetic rotors are caused to rotate simultaneously by the magnetic coupling in order to rotate the rollers in the rack.

11. A transfer conveyor for use with a cassette, the cassette adapted to store a plurality of substantially flat panels, the cassette comprising:
a frame having a first side and an opposing second side; and
a plurality of racks separately disposed on the frame at different levels, each rack adapted to store a flat panel, wherein each of the racks comprises:
a plurality of rollers for supporting the flat panel, each roller capable of rotating along a rotational axis in a first direction or in an opposing second direction; and
a mechanical coupling mechanism disposed on the first side of the rack, the coupling mechanism motionally engaged with the rollers, said transfer conveyor comprising:
a platform frame having a first frame side and an opposing frame side;
a plurality of platform rollers, each roller capable of rotating along a rotational axis in the first direction or the second direction, wherein the platform rollers are motionally engaged with each other such that the platform rollers can be caused to rotate simultaneously;
a further mechanical coupling mechanism disposed on the second platform side, the further mechanical coupling mechanism motionally engaged with the platform rollers; and
a movement means operatively linked to the further mechanical coupling mechanism for causing the platform rollers to rotate simultaneously in the first direction or the second direction, wherein the further mechanical coupling mechanism is adapted to engage mechanically with the mechanical coupling mechanism of one of the racks for causing the rollers on said rack to rotate simultaneously with the platform rollers in the same first or second direction.

12. The transfer conveyor of claim 11, wherein each of the platform rollers is mounted on a shaft for rotation, the shaft comprising at least one shaft gear fixedly disposed on the shaft, and the plurality of platform rollers on each rack include one or more adjacent platform roller pairs, and wherein the rack further comprises mechanical coupling means for mechanically engaging the shaft gears on the shafts of the platform rollers in each adjacent platform roller pair for motionally engaging said adjacent platform roller pair.

13. The transfer conveyor of claim 11, wherein the shaft has a first shaft end and a second shaft end, and said at least one shaft gear is fixedly disposed on the first shaft end.

14. The transfer conveyor of claim 13, where the shaft further comprises a further shaft gear fixedly disposed on the second end, and wherein the rack further comprises further mechanical coupling means for mechanically engaging the further shaft gears on the second end of the shafts of the platform rollers in said each adjacent platform roller pair for motionally engaging said adjacent platform roller pair.

15. The transfer conveyor of claim 14, wherein each of the mechanical coupling means and the further mechanical coupling means comprises an odd-number of coupling gears.

16. The transfer conveyor of claim 11, wherein each of the platform rollers is mounted on a shaft for rotation, and the plurality of platform rollers include one or more adjacent platform roller pairs, and wherein the rack further comprises one or more belts, each belt mechanically engaging with the shafts of the platform rollers in each adjacent platform roller pair for motionally engaging said adjacent platform roller pair.

17. The transfer conveyor of claim 11, wherein each of the platform rollers is mounted on a shaft for rotation, and the plurality of platform rollers include one or more adjacent platform roller pairs, and wherein the rack further comprises one or more chain, each chain mechanically engaging with the shafts of the platform rollers in each adjacent platform roller pair for motionally engaging said adjacent platform roller pair.

18. The transfer conveyor of claim 11, wherein each of the rollers is mounted on a shaft for rotation, the shaft comprising at least one magnetic rotor fixedly disposed on the shaft, said transfer conveyor further comprising:
a common shaft mechanically engaged with the further mechanical coupling mechanism; and
a plurality of magnetically inducing rotors fixedly mounted on the common shaft, each of the inducing rotors is positioned in relation with a magnetic rotor for providing magnetic coupling between said inducing rotor and said magnetic rotor, such that when the common shaft is caused to turn by the movement means through the further mechanical coupling mechanism, the inducing rotors are also caused to turn along with the common shaft and magnetic rotors are caused to rotate simultaneously by the magnetic coupling in order to rotate the platform rollers.

19. The transfer conveyor of claim 11, further comprising:
a lateral movement means for moving the platform frame toward or away from the cassette, wherein when the platform frame is moved toward the cassette so as to allow the further mechanical coupling mechanism to engage mechanically to the mechanical coupling mechanism of said one of the racks, the rollers on said rack are caused to rotate
in the second direction to move a flat panel from the second side of said rack to the first side of said rack and further to the platform frame toward the first frame side; or
in the first direction to move a flat panel from the first frame side to the second frame side of platform frame to said rack toward the second side.

20. The transfer conveyor of claim 19, further comprising:
a further moving means to adjust a vertical position of the platform frame to align with the level of said one of racks so as to move a flat panel from said rack or to move a flat panel to said rack.

21. A panel transfer system comprising:
one or more cassettes, each of the cassettes adapted to store a plurality of substantially flat panels, the cassette comprising:
a frame having a first side and an opposing second side; and
a plurality of racks separately disposed on the frame at different levels, each rack adapted to store a flat panel, wherein each of the racks comprises:
a plurality of rollers for supporting the flat panel, each roller capable of rotating along a rotational axis in a first direction or in an opposing second direction; and
a mechanical coupling mechanism disposed on the first side of the rack, the coupling mechanism motionally engaged with the rollers; and
a transfer conveyor position in relationship with said one or more cassettes, said transfer platform comprising:
a platform frame having a first frame side and an opposing frame side;
a plurality of platform rollers, each roller capable of rotating along a rotational axis in the first direction or the second direction, wherein the platform rollers are motionally engaged with each other such that the platform rollers can be caused to rotate simultaneously;
a further mechanical coupling mechanism disposed on the second platform side, the further mechanical coupling mechanism motionally engaged with the platform rollers, and
a movement means operatively linked to the further mechanical coupling mechanism for causing the platform rollers to rotate simultaneously in the first direction or the second direction, wherein the further mechanical coupling mechanism is adapted to engage mechanically with the mechanical coupling mechanism of one of the racks for causing the rollers on said rack to rotate simultaneously with the platform rollers in the same first or second direction in order to move a flat panel from or to said rack.

22. The panel transfer system of claim 21, further comprising:
a lateral movement means for moving the platform frame toward or away from the cassette, wherein when the platform frame is moved toward the cassette so as to allow the further mechanical coupling mechanism to engage mechanically to the mechanical coupling mechanism of said one of the racks, the rollers on said rack are caused to rotate
in the second direction to move a flat panel from the second side of said rack to the first side of said rack and further to the platform frame toward the first frame side; or
in the first direction to move a flat panel from the first frame side to the second frame side of platform frame to said rack toward the second side.

23. The panel transfer system of claim 22, further comprising:
a further moving means to adjust a vertical position of the platform frame to align with the level of said one of racks so as to move a flat panel from said rack or to move a flat panel to said rack.

24. The panel transfer system of claim 22, further comprising:
a conveyor movement means for moving the transfer conveyor to a selected one of said one or more cassette so as allow the platform frame to move a flat panel from or to the rack of the selected cassette.

25. A method for use with a cassette to move a substantially flat panel to or from the cassette, the cassette adapted for storing a plurality of flat panels, the cassette comprising:
a frame having a first side and an opposing second side; and
a plurality of racks separately disposed on the frame at different levels, each rack adapted to store a flat panel, wherein each of the racks comprises:
a plurality of rollers for supporting the flat panel, each roller capable of rotating along a rotational axis in a first direction or in an opposing second direction; and
a mechanical coupling mechanism disposed on the first side of the rack, the coupling mechanism motionally engaged with the rollers,
said method comprising the steps of:
1) locating a platform frame in relationship with the cassette, the platform frame having:
a first frame side and an opposing frame side;
a plurality of platform rollers, each roller capable of rotating along a rotational axis in the first direction or the second direction, wherein the platform rollers are motionally engaged with each other such that the platform rollers can be caused to rotate simultaneously; and
a further mechanical coupling mechanism disposed on the second platform side, the further mechanical coupling mechanism motionally engaged with the platform rollers;
2) engaging the further mechanical coupling mechanism to the mechanical coupling mechanism;
3) operatively linking a movement means to the further mechanical coupling mechanism for causing the platform rollers to rotate simultaneously in the first direction or the second direction and further causing the rollers the rollers on said rack through the mechanical coupling mechanism to rotate simultaneously with the platform rollers in the same first or second direction in order to move the flat panel from or to said rack.
